(19) United States
(12) Patent Application Publication
(10) Pub. No.: US 2004/0223179 A1
(43) Pub. Date: Nov. 11, 2004

(54) Network printing mode automation

(76) Inventors: Duane E. Mentze, Roseville, CA (US); Brett J. Williams, Roseville, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/434,314

(22) Filed: May 7, 2003

(51) Int. Cl. G06F 3/12; G06F 15/00; G06F 15/16

(52) U.S. Cl. 358/1.15; 719/321; 709/238

(57) ABSTRACT

In one embodiment of the invention, a method of providing network printing mode automation, includes: storing attributes in a network printer device, where the attributes indicate an intended printing model for a printing infrastructure; reading the attributes by a client to determine the intended printing model; and configuring the client based upon the intended printing model so that an appropriate print path is created from the client to a destination. In another embodiment, an apparatus for providing network printing mode automation, includes: a communications network; a network printer configured to store attributes, where the attributes indicate an intended printing model for a printing infrastructure; and a client coupled to the network printer by the communications network, the client including an installer configured to read the attributes to determine an intended printing model and configured to set the client based upon the intended printing model so that an appropriate print path is created from the client to a destination.

### TECHNICAL FIELD

Embodiments of the present invention relate generally to network printing technology, and more particularly to network print mode automation.

### BACKGROUND

Network printing today has two (2) predominant models: peer-to-peer and client-server. Other types of network printing models are also currently being used. The peer-to-peer model is the situation where client devices send out print jobs to a network printer device by sending the print jobs directly to the network printer device. The client-server model is the situation where a client device sending a print job over the network actually sends the print job to a server network device. The server network device then sends the print job to the network printer device. The server network device typically accepts jobs from many sending client devices, and also the server network device then sends the print jobs to one or more printers. Print jobs are typically stored on a hard drive and use a process called “spooling”. This spooling process is performed because in larger network environments, many users may send print jobs simultaneously from their client devices to one (1) printer. The server network device allows a network administrator to administrate the network printers in the client-server model in a much more controlled fashion than in the peer-to-peer model.

Network print installations are performed today by using a variety of methods, as well as by using many different tools. The most predominant methods are:

(1) add printer wizard;

(2) point and print;

(3) administrative tools such as webJetAdmin;

(4) manufacturers' installers that are shipped with the actual printers.

The tools and methods used for network print installations vary depending on the knowledge of the person performing the install task, the desired print model, the personal preference of the administrator and/or of the user, accessibility of tools, ease of use of tools, and/or other factors.

A common method to permit a large environment organization to use the client-server model would be for an administrator to configure a spooling server, and then to communicate to the organization the UNC (universal naming convention) path to the spooling server for a specific printer. However, if a user uses a tool other than point and print, the user would then most likely create a peer-to-peer connection to the printer, bypassing the intended model for that environment.

Therefore, in current technology, if a network administrator permits a user(s) to independently install print tools for his/her computer, the print tool installation(s) might occur such that the administrator may not be able to manage the printing infrastructure in a computer network. Thus, the current approaches and/or technologies present these and other problems.

### SUMMARY OF EMBODIMENTS OF THE INVENTION

In one embodiment of the invention, a method of providing network printing mode automation, includes: storing attributes in a network printer device, where the attributes indicate an intended printing model for a printing infrastructure; reading the attributes by a client to determine the intended printing model; and configuring the client based upon the intended printing model so that an appropriate print path is created from the client to a destination.

In another embodiment, an apparatus for providing network printing mode automation, includes: a communications network; a network printer configured to store attributes, where the attributes indicate an intended printing model for a printing infrastructure; and a client coupled to the network printer by the communications network, the client including an installer configured to read the attributes to determine an intended printing model and configured to set the client based upon the intended printing model so that an appropriate print path is created from the client to a destination.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a network printing system that can implement an embodiment of the invention.

FIG. 2 is a block diagram of a printer device, in accordance with an embodiment of the invention.

FIG. 3 is a block diagram of stored information that stores a printing mode, as used in an embodiment of the invention.

FIG. 4 is flowchart of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

In current technology, if a network administrator permits a user(s) to independently install print tools for his/her computer, then the print tool installation(s) might occur such that the administrator may not be able to manage the printing infrastructure in a computer network. For example, an administrator may have designed the printing infrastructure such that print jobs are spooled and printed to a specific spooler in a server. This specific spooler may, for example, permit the administrator to manage and account for print jobs, track current print jobs, and/or discover printing problems such as printer jams by use of the specific spooler. However, a user who is independently installing print tools in his/her computer might be unaware of the specific spooler that has been installed by the administrator. As a result, the user might completely bypass the spooler and set up the printing configuration for his/her computer to occur from his/her computer directly to the printer (i.e., use a peer-to-peer printing mode); this results in the administrator to not be able to account and/or manage for the print jobs from this user's particular computer, and to not be able to obtain the benefits associated with the accounting and management of the printing infrastructure. Thus, an embodiment of the invention advantageously provides a method and apparatus (system) to permit the administrator to manage the printing infrastructure in a computer network.

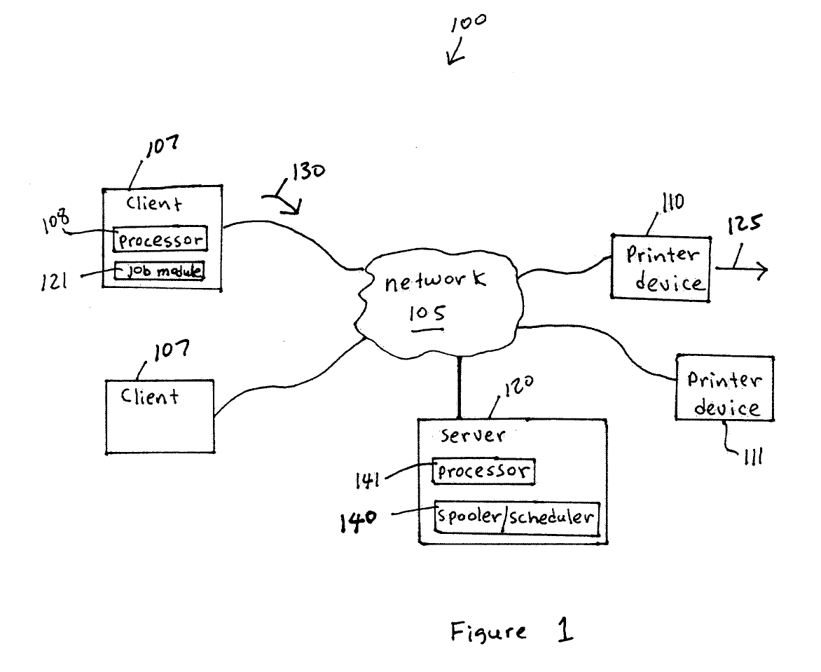

FIG. 1 is a block diagram of a network printing system 100 that can implement an embodiment of the invention. In the example network printing system 100, a network 105 permits communications between various devices that are coupled in the network 105.

In an embodiment, the network printing system 100 includes the following components: one or more client computers 107, and one or more printer device (e.g., printer devices 110 and 111 in the example of FIG. 1). A server 120 may also be included in the network printing system 100 to perform various functions such as print spooling, if a client-server printing mode (i.e., the client-server model) is used in the printing infrastructure as previously described above.

The network printing system 100 also typically includes other components that are known and are used for permitting functions in a communication network. For purposes of focusing on the embodiments of the invention, these other known components are not shown in FIG. 1.

In an embodiment, a client computer 107 is typically a computer (e.g., personal computer) that execute under the control of an operating system, such as the WINDOWS operating system from MICROSOFT CORPORATION. However, those skilled in the art will recognize that a client computer 107 may be any suitable type of computer such as, for example, a laptop, notebook, palmtop, server, workstation, mainframe, minicomputer, or other types of computing devices, and the operating system may be any suitable operating system, such as, for example, OS/2, OS/390, MACINTOSH, UNIX, LINUX, or other types of operating system software. The operating system and other software or firmware in a client computer 107 are executed by a processor 108 in the client computer 107.

Each client computer 107 also includes a print job module 121 to allow a user to create and submit a print job 130 that is transmitted over the network 105 directly to a printing device 110 (if peer-to-peer mode is used by the client device 107) or to a server 125 which is linked to one or more printing device such as printers 110 and 111 (if client-server mode is used by the client device 107).

In the client-server mode, the server 120 includes a spooler/scheduler 140 that receives print jobs 130 from the client computers 107 and generates printer files that are transmitted to one of the printing devices 110 and 111 that can appropriately handle the print job 130. In this way, the user may elect to not specify a printer in the network printing system 100 for printing the print job 130 and let the spooler/scheduler 140 to select an appropriate printing device to perform the printing operation. Therefore, if the printing infrastructure of the system 100 is based on the peer-to-peer printing mode, then the server 120 may be omitted in the system 100.

The server 120 includes a processor 141 to execute the spooler/scheduler 140 and other software or firmware in the server 120. After processing the print job 130 and selecting a destination printer (e.g., printer device 110 or printer device 111) for the print job 130, the spooler/scheduler 140 in the server 120 sends the print job 130 to the selected destination printer device.

It is noted that printers may have different printing capabilities. Thus, for a given submitted print job, some printers in a network may not be able to process the print job.

A print job 130 is typically formed by one or more electronically-stored files and the print attributes for the print job. The print attributes inform a printer device 110 on how to process the files that are in the print job 130. The print job module 121 permits a user to select print attributes for a print job 130. The processor 108 in the client computer 107 will then execute the print job module 121 to create an electronically-stored job ticket based on the information entered by the user.

Various known components and modules that permit a user to use a client computer 107 and to permit the client computers 107 to interface in the network 100 are not shown in FIG. 1 for purposes of describing a functionality of embodiments of the invention.

The printing device 110 may be a printer for generating printed output 125 from print jobs 130. Alternatively, the printing device 110 may be other types of devices, such as a copy machine, fax machine, or digital projector that can generate printed output 125 from print jobs 130.

In a network 105 with a printing infrastructure, the printing device 110 forms a single focal point for devices that are in the network 105. Various known components and modules that permit the printing device 110 to process print jobs 130, generate printed output 125, and to interface in the network 105 are not shown in FIG. 1 for purposes of describing a functionality of embodiments of the invention.

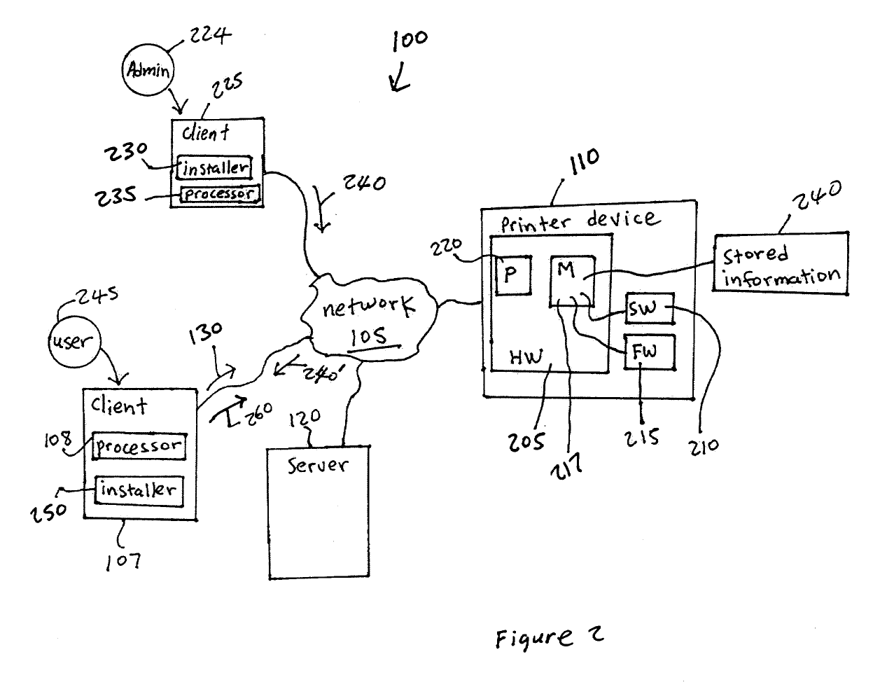

In an embodiment, one or more printing devices 110 will store information 240 (FIG. 2) about how the printing device 110 will participate in the printing infrastructure of system 100, and this stored information 240 can be referenced by and used by software tools that are being used to install and to configure the printing infrastructure of system 100. The printing device ill and/or other printing devices that may be installed in the system 100 may also store the information 240.

It should be appreciated that, in alternative embodiments, the network printing system 100 may include components and products other than those discussed above. Moreover, the network printing system 100 can be implemented on different operating systems and hardware. Printers having printing capabilities different from the disclosed printers may be used. Further, in alternative embodiments, any number of client computers having alternative user interfaces may be used. Those skilled in the art will recognize that other alternative hardware and software environments may be used without departing from the scope of embodiments of the invention. As such, the exemplary environment in FIG. 1 is not intended to limit embodiments of the invention.

FIG. 2 is a block diagram of a printer device 110, in accordance with an embodiment of the invention. The printer device 110 includes standard printer hardware 205 and standard printer software 210 and firmware 215 for performing printing functions. The software 210 and firmware 215 are typically stored in a memory 217. A processor 220 in the printer hardware 205 can execute the software 210 and firmware 215.

In an embodiment of the invention, a network administrator will, for example, use a client computer 225 for the initial setup for the network printer 110 in the system 100. An initial setup installer 230 (executed by a processor 235) permits the network administrator to enter the printing model (e.g., peer-to-peer, client-server, or another printing model) is to be used in the printing infrastructure for system 100. An installer can be configured to ask the user to enter the desired configuration options for the main program or hardware, and sets up various initialization files accordingly, as well as copying the main program to a hard disc. In an embodiment, the installer 230 is implemented as firmware in memory of the client 225.

The printing model information (whether peer-to-peer, client-server, or other printing model) is transmitted as information 240 by the installer 230 to the printer device 110. The information 240 is transmitted via network 105 in the form of a data packet that is received by the printer device 110 and processed by the printer processor 220. The information 240 may then be stored into the memory 217 by the printer processor 220.

The information 240 will indicate the printing model of the network infrastructure 105. For the case of the client-server model, the information 240 will indicate this printing mode as an attribute, and the actual server 120 performing the print spooling is also stored, for example, as a UNC (universal naming convention) path (e.g., \\servername\printshare). The UNC path is typically stored as an attribute in the stored information 240 which is, in turn, stored in the memory 217 of the printer 110. As known to those skilled in the art, in a network, UNC is a way to identify a shared file in a computer without having to specify (or know) the storage device that the shared file is on. Printers and other devices can be addressed by using UNC.

Therefore, the printer device 110 will store information 240 about how the printer device 110 will participate in the printing infrastructure of system 100, and this stored information can be referenced by and used by the tools that are being used to install and configure the printing infrastructure. It is also noted that more than one printer device 110 in the system 100 can store the information 240. For purposes of focusing on the functionalities of the embodiments of the invention, only one printer device 110 is shown in FIG. 2.

In an embodiment of the invention, a user 245 subsequently uses an installer 250 (e.g., in client 107) which simply discovers network printers. After the user 245 selects to use the particular network printer device 110, then the installer 250 can read the stored information 240 in the printer device 110 to determine the printing mode that has been set for the network printer 110 or to determine if the printing mode has been set for the network printer 110. If the printing mode has been set for the printer 110, then the installer 250 can simply use that printing mode information to direct the rest of the install. For example, if the network printer 110 has been configured to use the client-server model, the installer 250 simply reads (from the network printer device 110) the server 120 performing the sharing. The installer 250 then uses this information to configure the client 107 to print (send) the print jobs 130 to the spooling server 120.

As another example, if the network printer 110 has been configured to use the peer-to-peer model, then the installer 250 would configure the client 107 to print (send) the print jobs 130 directly to the network printer device 110. As another example, if the network printer 110 has been configured to use another type of printing model, then the installer 250 would configure the client 107 to send the print job 130 in accordance with the requirement of the printing model.

The installer 250 obtains the printing model of the printer device 110 by instructing the processor 108 to send a request 260 to the printer device 110. The printer processor 220 in the printer device 110 receives and processes the request 260 and retrieves the stored information 240 from the memory 217 in response to the request 260. The printer processor 220 then sends an image 240′ of the stored information 240 to the client device 107 as a packet. The client processor 108 then receives and processes the image 240′ so that the installer 250′ can configure the client 107 to send a print job 130 based upon the intended printing model information as indicated in the image 240′. The intended printing model information is used by the print job module 121 (FIG. 1) to generate and transmit a print job 130 to an appropriate destination. For example, if the printing model is peer-to-peer, then the print job 130 is transmitted directly to the printer device 110 by a print path created by the installer 250. As another example, if the printing model is client-server, then the print job 130 is transmitted directly to the spooling server 120 by a print path created by the installer 250.

If an administrator 224 were to run an initial setup installer 230 that discovers the network printer(s) 110 in the system 100 and that sets values in the attributes of stored information 240 and also configure the spooler 140 to be aware of that printers 110 (in the case of the client-server model), then later on, if a user 245 were to run another installer 250 that discovers the network printer(s) 110 on the network system 100, then the installer 250 can look at the values that were set in the attributes of stored information 240 and the installer 250 can determine if the printing model should be peer-to-peer and then create a print path where the client 107 will talk straight to the printer 110. Alternatively, if the installer 250 determines that printing model is client-server by looking at the values in the attributes of stored information 240, then the installer 250 creates a print path that communicates to a spooling server 120.

The installer 250 could be changed to include the check for the print mode information, for example, through standard management protocols such as SNMP (Simple Network Management Protocol). Once the client 107 has obtained the print mode, then the installer 250 would use that print mode information to configure the client 107 appropriately. In the WINDOWS case, for peer to peer, it involves port creation, possibly port monitor installation, driver installation, and printer creation, and for the client-server model, the installer 250 calls AddPrinter with the UNC path to the server share, possibly pre-installing the driver.

The installer 250 may optionally check if the print share exists on the spooling device, which is server 120 in the example of FIG. 2. The network printer 110 may also optionally check if the print share exists on the spooling device.

Administrators will be able to directly store the intended printing model (and any settings for the printing model) into one or more network printers 110 in the system 100. The printing model may be, for example, peer-to-peer, client-server, or other printing models. It is noted that there are no settings in the stored information 240 for the peer-to-peer model. However, the clients-server model typically needs two network identifier (ID) for the spooling server 110. The IDs are typically the server ID and the name of the print share (sometimes called the print queue). These IDs can be stored as an attribute in the information 240.

The installers 250 in client devices 107 can take advantage of the stored information 240 to discover the network administrator's intended printing model and to correctly configure the client devices 107 to properly print to the network printer device 110 based upon the intended printing model. This will reduce the number of configuration errors for client devices 107.

Embodiments of the invention make it easier for a user 245 to properly access a network printer device 110. For example, if a user found a physical printer device that he/she wanted to use in a network system, in current technology it would be difficult to determine the intended printing mode of the desired network printer device. If the printing mode of the desired network printer device was the client-server model, then the user would also need to determine the UNC path to the spooling server for that printer. Since the configuration information is located within a particular location in the spooling server, obtaining the UNC path information can be difficult.

In contrast, with an embodiment of this invention, a user 245 could simply acquire the network address of a desired printer device 110 (via a test page printout or via the printer display if provided in the printer device), and then use an installer 250 which can query the intended printing mode and printing mode settings in the stored information 240 in the desired printer device 110. Alternatively, the user can perform a printer discovery and will be presented with a list of printers.

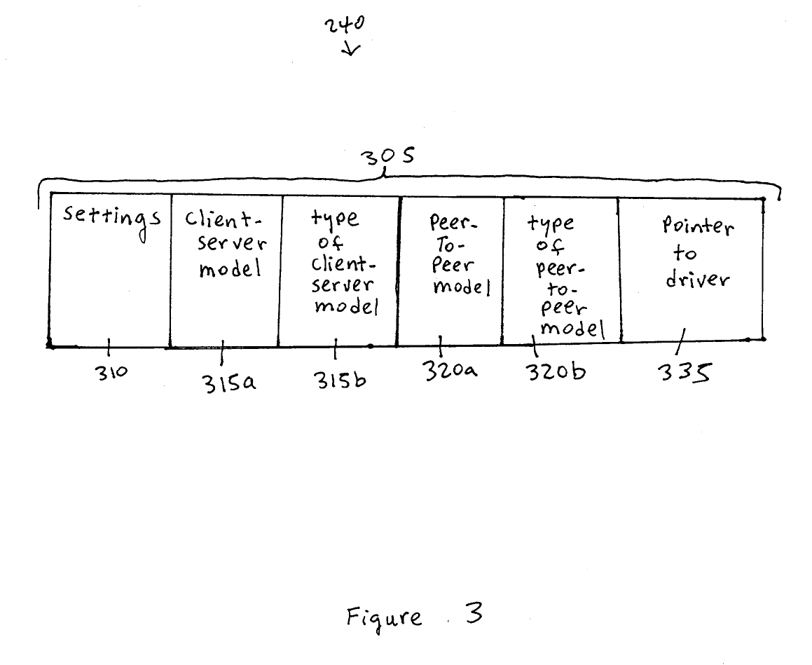

FIG. 3 is a block diagram of stored information 240 that stores a printing mode, as used in an embodiment of the invention. The stored information 205 includes attributes 305 that an installer 250 can intelligently use to determine the printing mode of the printing infrastructure of the network printing system 100. The stored information 240 can also include attributes that an installer 250 can intelligently use to determine where to obtain the print drivers. To store and access an attribute value in the memory 217 of a network printer device 110, the printer processor 220 can use standard management techniques for attributes.

The attributes 240 can include, for example, the following fields with values that set the attributes 240. The values in field 310 will determine the settings for the intended printing mode of the printing infrastructure of system 100. For example, in the client-server model, the field 310 can include at least one network identifier (ID) for the spooling server 120.

Field 315a will contain values that can be set to indicate that intended printing mode of the printing infrastructure of system 100 is the client-server model.

There are several types of client-server printing models, which usually vary by the type of spooler being used: windows print share, novel NDS (Novell Directory Services), and novel bindery are three examples of the client-server model. Field 315b will contain values that can be set to indicate specific type of client-server model (e.g., windows print share, novel NDS, or other specific type). The client server model discussed above matches the windows print share example. There may be different settings needed for the various different client server print spoolers chosen. The settings may be set in, for example, settings field 310 or other fields in the attributes 305.

Field 320a will contain values that can be set to indicate that intended printing mode of the printing infrastructure of system 100 is the peer-to-peer mode. There are several specific types of peer-to-peer printing models. Two types of peer to peer are “direct mode IP (Internet Protocol)” and “direct mode IPX (Internetwork Packet Exchange)”. There may be other types of peer-to-peer models as well. Field 320b will contain values that can be set to indicate specific type of peer-to-peer model (e.g., direct mode IP, direct mode IPX, or other specific type).

Field 335 will contain values that can be set to indicate to the installer 250 of where to obtain the print drivers. The information in field 335 may be, for example, a network pointer (e.g., Uniform Resource Locator or URL) to a driver that will be required to be used by a client computer 107.

Some of the fields in FIG. 3 may be omitted, and other additional fields may also be added.

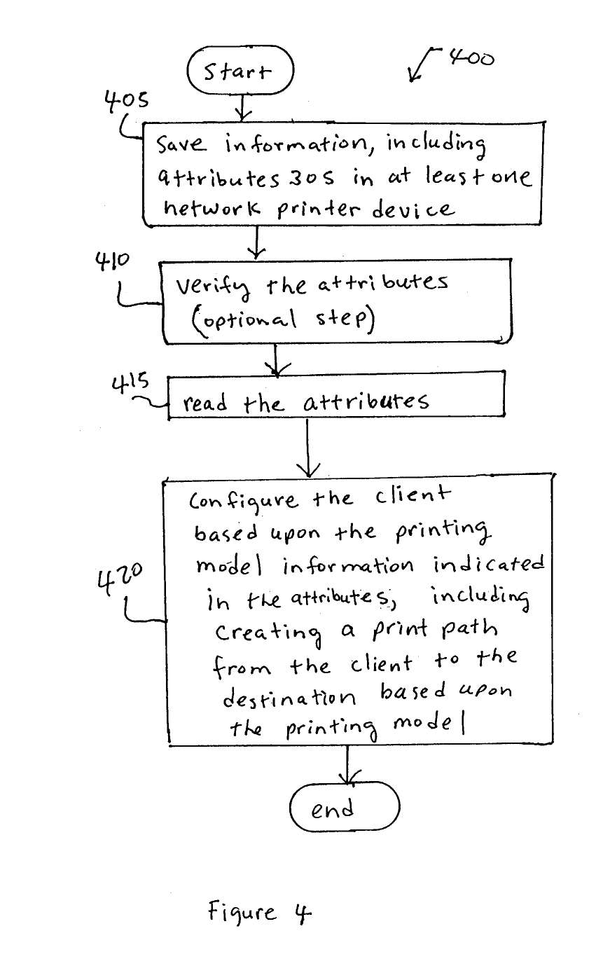

FIG. 4 is flowchart of a method 400 in accordance with an embodiment of the invention. The initial setup installer 230 first saves (405) the information 240, including attributes 305, into at least one network printer device 110. The attributes 305 will indicate the intended printing model of the printing infrastructure of the system 100.

The attributes 305 may be verified (410) by the network printer device 110, as an optional step. The printer processor 220 may perform the attribute verification steps and can give an indication of errors that are discovered during the verification of the attributes 305. An error indication may occur if, for example, a user 245 commands a client 107 to print to the printer device 110 directly, by use the IPX (Internetwork Packet Exchange) networking protocol, but the printer device 110 does not have IPX as a stack. An error indication may also occur if, for example, a user 245 commands a client 107 to print to a WINDOWS print share (e.g., Windows 95/Windows NT Print Share) in a server, but the print share is not in the server

Alternatively, the attributes 305 can be stored in the printer device 110 as unverified. The installer 250 may need to actively verify the attribute 305, as a practical matter, by use of standard data verification techniques Device can give an indicator to indicate a type of error.

The stored attributes 305 in the printer device 110 is then read (415) by the installer 250 in the client 107. The installer 250 will then configure (420) the client based the printing models indicated in the attributes, including creating a print path from the client to the destination based upon the printing model. The client 107 can then print to the appropriate destination, and the method 400 ends.

The various engines, tools, or modules discussed herein may be, for example, software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

While the present invention has been described herein with reference to particular embodiments thereof, a latitude of modification, various changes and substitutions are intended in the foregoing disclosures, and it will be appreciated that in some instances some features of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular embodiment disclosed as the best mode contemplated for carrying out this invention, but that the invention will include all embodiments and equivalents falling within the scope of the appended claims.

What is claimed is:

1. A method of providing network printing mode automation, the method comprising:
storing attributes in a network printer device, where the attributes indicate an intended printing model for a printing infrastructure;
reading the attributes by a client to determine the intended printing model; and
configuring the client based upon the intended printing model so that an appropriate print path is created from the client to a destination.

2. The method of claim 1, wherein the attributes include a network pointer to a driver that will be required to be used by the client.

3. The method of claim 1, wherein the printing model is a peer-to-peer model.

4. The method of claim 3, wherein the appropriate print path is from the client to the network printer device.

5. The method of claim 1, wherein the printing model is a client-server model.

6. The method of claim 5, wherein the appropriate print path is from the client to a spooling server.

7. The method of claim 1, wherein the intended printing model is determined by a network administrator.

8. The method of claim 1, wherein the attributes are stored in memory.

9. An apparatus for providing network printing mode automation, the apparatus comprising:
a communications network;
a network printer configured to store attributes, where the attributes indicate an intended printing model for a printing infrastructure; and
a client coupled to the network printer by the communications network, the client including an installer configured to read the attributes to determine an intended printing model and configured to set the client based upon the intended printing model so that an appropriate print path is created from the client to a destination.

10. The apparatus of claim 9, wherein the attributes include a network pointer to a driver that will be required to be used by the client.

11. The apparatus of claim 9, wherein the printing model is a peer-to-peer model.

12. The apparatus of claim 11, wherein the appropriate print path is from the client to the network printer device.

13. The apparatus of claim 9, wherein the printing model is a client-server model.

14. The apparatus of claim 13, wherein the appropriate print path is from the client to a spooling server.

15. The apparatus of claim 13, wherein the intended printing model is determined by a network administrator.

16. The apparatus of claim 13, wherein the network printer device includes a memory configured to store the attributes.

17. An apparatus for providing network printing mode automation, the apparatus comprising:
means for storing attributes in a network printer device, where the attributes indicate an intended printing model for a printing infrastructure;
means for reading the attributes by a client to determine the intended printing model; and
means for configuring the client based upon the intended printing model so that an appropriate print path is created from the client to a destination.

18. A method of providing network printing mode automation, the method comprising:
reading attributes stored in a network printing device to determine an intended printing model; and
performing device configuration based upon the intended printing model.

19. The method of claim 18, wherein the attributes include a network pointer to a driver that will be required to be used by the client.

20. The method of claim 18, wherein the printing model is a peer-to-peer model.

21. The method of claim 20, wherein an appropriate print path is from the client to the network printer device.

22. The method of claim 18, wherein the printing model is a client-server model.

23. The method of claim 22, wherein an appropriate print path is from the client to a spooling server.

24. The method of claim 18, wherein the intended printing model is determined by a network administrator.

25. The method of claim 18, wherein the attributes are stored in memory.

26. An article of manufacture, comprising:
a machine-readable medium having stored thereon instructions to:
read attributes stored in a network printing device to determine an intended printing model; and
perform device configuration based upon the intended printing model.
